(19) United States
(12) Patent Application Publication
(10) Pub. No.: US 2011/0164890 A1
(43) Pub. Date: Jul. 7, 2011

(54) METHOD AND APPARATUS FORMING IMAGE

(75) Inventor: Hiroshi Ota, Tokyo-to (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/978,808

(22) Filed: Dec. 27, 2010

Related U.S. Application Data
(60) Provisional application No. 61/292,048, filed on Jan. 4, 2010.

(51) Int. Cl. G03G 15/20

(52) U.S. Cl. 399/43; 399/69; 399/45

(57) ABSTRACT

According to one embodiment, a fuser including, a heating unit configured to heat a toner to be fixed on a sheet medium and the sheet medium and including at least three heat sources that can be independently driven, a temperature detecting unit configured to detect temperature of the heating unit in at least two positions spaced apart in a longitudinal direction of the heating unit, and a control unit configured to change power supply to the heat sources of the heating unit according to elapse time from the power supply to the heat sources, a number of sheet media to be continuously processed, and a type of the sheet media.

### CROSS-REFERENCE TO RELATED APPLICATIONS

This application is based upon and claims the benefit of priority from: U.S. Provisional Application No. 61/292,048 filed on Jan. 4, 2010, the entire contents of each of which are incorporated herein reference.

### FILED

Embodiments described herein relates generally to an image forming apparatus and a method for monitoring jobs.

### BACKGROUND

A toner (a visualizing agent) moves to a sheet medium on the basis of image information and is integrated with the sheet medium. The sheet medium (integrated with the toner) is a hard copy.

A fuser unit integrates the toner with the sheet medium.

### BRIEF DESCRIPTION OF THE DRAWINGS

FIG. 1A is an exemplary diagram showing an example of an MFP, according to an embodiment;

FIG. 1B is an exemplary diagram showing an example of an MFP, according to an embodiment;

FIG. 2 is an exemplary diagram showing an example of a fuser of the MFP according to an embodiment;

FIG. 3 is an exemplary diagram showing an example of a fuser of the MFP according to an embodiment;

FIG. 4 is an exemplary diagram showing an example of a fuser of the MFP according to an embodiment;

FIG. 5 is an exemplary diagram showing an example of a fuser of the MFP according to an embodiment; and

FIG. 6 is an exemplary diagram showing an example of power control of heater elements of the fuser according to an embodiment.

### DETAILED DESCRIPTION

In general, according to an embodiment, a fuser comprising: a heating unit configured to heat a toner to be fixed on a sheet medium and the sheet medium and including at least three heat sources that can be independently driven; a temperature detecting unit configured to detect temperature of the heating unit in at least two positions spaced apart in a longitudinal direction of the heating unit; and a control unit configured to change power supply to the heat sources of the heating unit according to elapse time from the power supply to the heat sources, a number of sheet media to be continuously processed, and a type of the sheet media.

Embodiments will now be described hereinafter in detail with reference to the accompanying drawings.

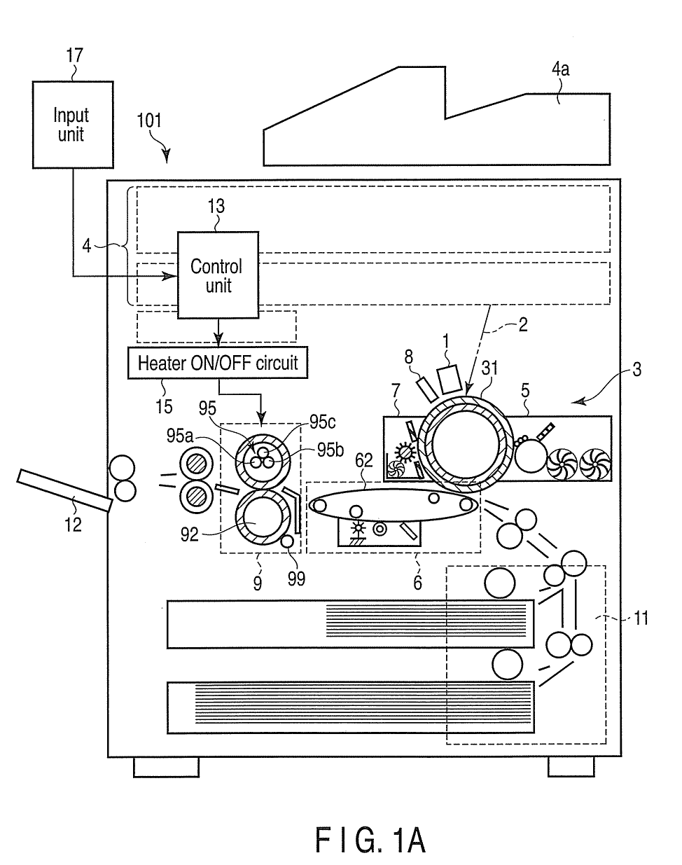

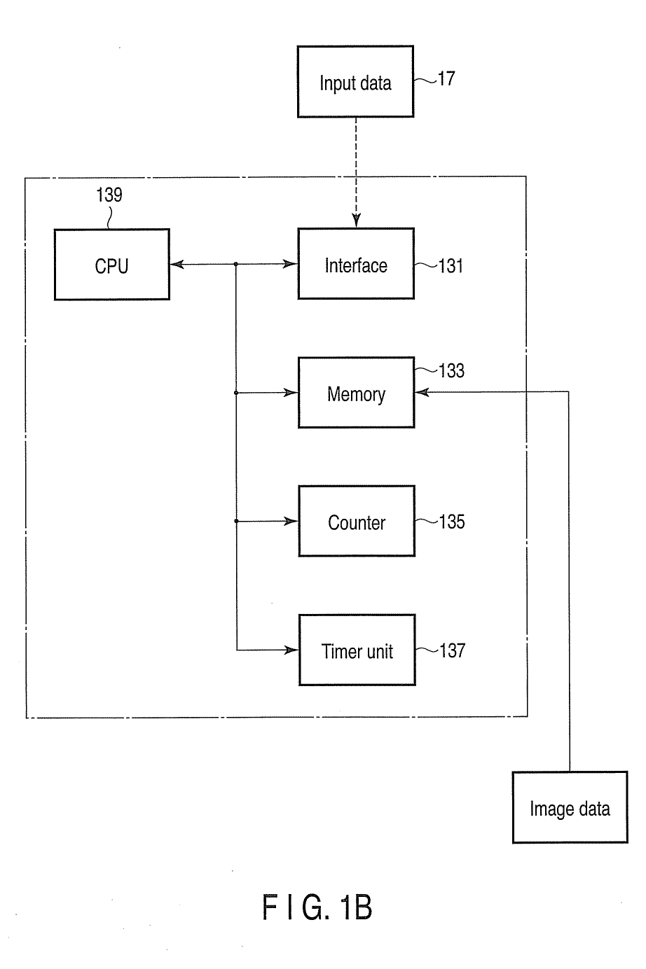

FIG. 1 shows an example of an outline of an MFP (Multi-Functional Peripheral, an electronic apparatus).

An image forming apparatus (MFP: Multi-Functional Peripheral) 101 shown in FIG. 1A includes at least a charging unit 1, a writing (exposing) unit 2, an image forming (latent image forming, developing, transferring, and cleaning) unit 3, a document reading unit 4 with an automatically feeding unit (ADF) 4a, a developing unit 5, a transfer unit 6, a cleaning unit 7, a charge removing unit 8, and a fuser unit 9.

The charging unit 1 gives charges having predetermined polarity (in this example, “− (minus)”) to a photoconductive layer on the surface of an image bearing member, for example, a cylindrical drum 31 included in the image forming unit 3 explained below. The image bearing member is not limited to the cylindrical drum and may be an endless belt or a cylindrical drum member located on the inner side of the endless belt. The writing (exposing) unit 2 irradiates exposure light, for example, a laser beam, light intensity of which changes according to image information as a target of image formation, on the photoconductive layer on the surface of the cylindrical drum (hereinafter referred to as photoconductive drum) 31 charged by the charging unit 1 and changes the potential of the photoconductive layer. A latent image is formed in a section where the potential is changed. The image information is provided by the document reading unit 4 explained below or an external apparatus such as a PC (Personal Computer) or a facsimile. The photoconductive drum 31 has an external diameter of, for example, 100 mm and includes a photoconductive layer 33 on the surface of a metal substrate (hollow aluminum) 32 as indicated by an example shown in FIG. 3. The photoconductive layer includes, for example, an organic photoconductive member (OPC).

The image forming (latent image forming, developing, transferring, and cleaning) unit 3 conveys a toner image obtained by developing (visualizing) the latent image with toner (a visualizing agent) provided by the developing device 5 to the transfer unit 6, the cleaning unit 7, and the charge removing unit 8 according to the rotation of the image forming unit 3. The photoconductive drum 31 rotates, for example, clockwise (in a CW (clockwise) direction) at predetermined speed.

The document reading unit 4 includes a document reading device. The document reading device includes, for example, a CCD sensor with 600 dpi (dots per inch)/7500 pixels (a total number of pixels in a longitudinal direction thereof) and converts image information as a reflected light signal of irradiated light into an electric signal.

The developing unit 5 includes a magnet roller and a developing sleeve locates on the outer circumference of the magnet roller and rotates on the outer circumference. The magnet roller selectively provides toner, which moves on the surface of the developing sleeve according to the rotation of the developing sleeve, to the latent image on the surface of the photoconductive drum 31 while magnetically attracting the toner. A space between the developing sleeve and the photoconductive drum 31 is managed by a guide roller set in contact with the surface of the photoconductive drum 31. The developing sleeve is formed of a nonmagnetic material such as stainless steel or aluminum.

The transfer unit (the peeling unit) 6 moves, with an electric field provided by a transfer roller, the toner image onto a sheet conveyed by a sheet conveying belt 62 (toners forming the toner image subjected to the electric field provided by the transfer roller move to the sheet). A peeling unit separates the toner (the toner image) and the sheet from the surface of the photoconductive drum.

In the cleaning unit 7, include a waste toner and foreign matter storing unit and stores a transfer residual toner (a waste toner), fiber pieces of a sheet, a surface coating agent, or the like scraped off by a removing mechanism such as a brush member (or a brush roller having a cylindrical brush) or a foreign matter conveyed together with the sheet.

The charge removing unit 8 resets the potential of the photoconductive layer on the surface of the image bearing member 31 to an initial state before the charging by the charging unit 1 (removes residual charges on the photoconductive member). The charge removing unit 8 includes an LED array in which LED elements configured to output red light having wavelength longer than, for example, 770 nm are arranged in an axis direction of the drum 31.

The image forming apparatus 101 further includes a paper feeding unit 11 configured to feed a sheet to the transfer unit 6 of the image forming unit 3 and a paper discharge unit 12 configured to receive a sheet on which a toner image is fixed by the fixing unit 9. The image forming apparatus 101 forms a toner image corresponding to image information provided by the document reading unit 4 or an apparatus such as a PC (Personal Computer) or a facsimile.

Specifically, when image formation is instructed from an operation unit or an external apparatus not shown in the figure, process control by the image forming unit 3 and fixing temperature control by the fixing unit 9 are started according to the control by the control unit 13. A copy output or a printout (a print output) is output by, for example, latent image formation, development, transfer, and cleaning in the image forming unit 3, movement of the toner image to the sheet from the paper feeding unit 11 by the transfer and peeling unit 6, and sheet conveyance control according to image information input by the document reading unit 4 or the external apparatus.

As indicated by an example shown in FIG. 1B, a control unit 13 includes an interface 131 configured to receive an input value from a control input unit (an operation unit) 17 to which the number of output images (outputs) and output image magnification corresponding to image information acquired by the ADF 4a and the reading unit 4, the size of a sheet medium, a printing start signal, and the like can be input, a memory 133 configured to store the input numerical value data (input value), the acquired (input) image information, and the like, a counter 135 configured to count the remaining number of sheets to which the image is output, a timer unit 137 configured to calculate time until the end of the image output referring to the remaining number of sheets to which the image is output stored by the counter 135, and a main control device (a CPU) 139.

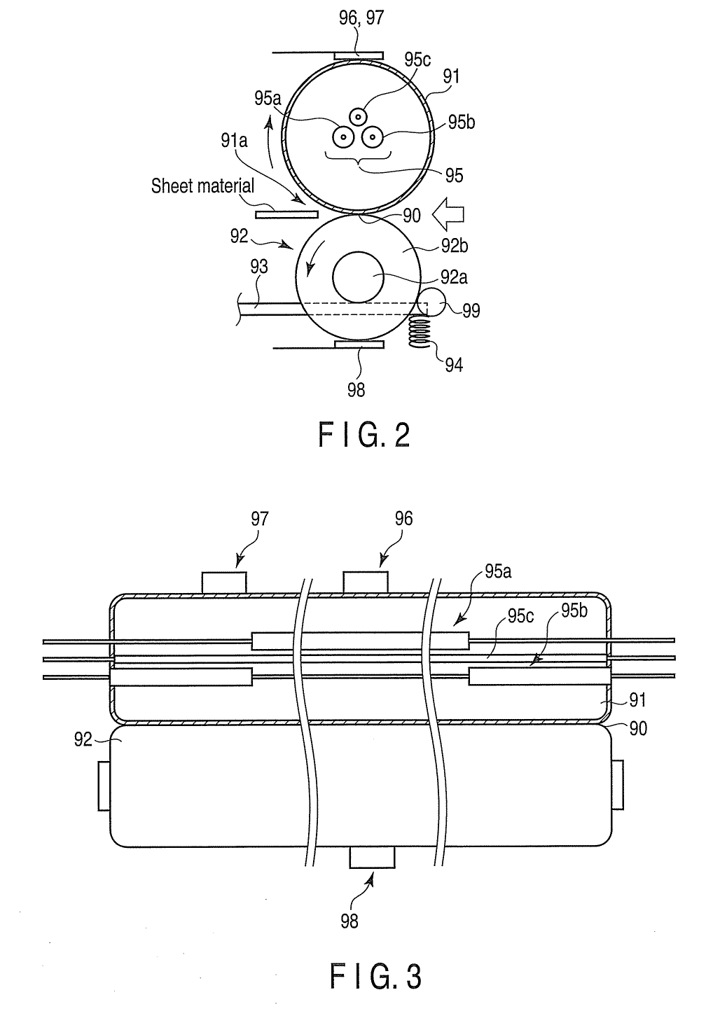

The fuser unit 9 includes, as indicated by an example shown in FIG. 2, a first roller 91 (e.g., φ30 mm) and a second roller 92 (e.g., φ30 mm) that provide a nip 90. The outer circumferential surface of one roller is brought into contact with the outer circumferential surface of the other roller by a spring 94 that gives pressure to a roller supporting member 93 configured to support the first roller 91 or the second roller 92. Pressure between the two rollers 91 and 92 is, for example, 150 N (Newton). The first roller 91 rotates such that the outer surface thereof moves at speed, i.e., circumferential speed of 130 mm. The second roller 92 rotates, according to the rotation of the first roller 91, at circumferential speed substantially the same as that of the first roller 91. In the following explanation, the first roller 91 is defined as a heating roller and the second roller 92 is defined as a pressing roller.

The material of the heating roller 91 is, for example, aluminum. The thickness of the heating roller 91 is, for example, 0.8 mm. The surface of the heating roller 91 includes a release layer made of fluorine resin (ethylene tetrafluoride resin) or the like.

The pressing roller 92 includes, around a shaft 92a, an elastic layer 92b made of silicon rubber, fluorine rubber, or the like. A cleaning roller 99 configured to clean the surface (the outer circumference) of the pressing roller 92 is located in a predetermined position on the outer circumference.

A pawl member 91a configured to peel off a sheet medium, which passes through the nip 90, i.e., between the heating roller 91 and the pressing roller 92, from the heating roller 91 is located in a predetermined position on the outer circumference of the heating roller 91.

A heating device 95 is located on the inner side of the heating roller 91. The heating device 95 includes three heater lamps 95a, 95b, and 95c as heat sources. The respective heater lamps include, for example, halogen lamps. The heater lamp (a center lamp) 95a heats (substantially) the center (in the longitudinal direction) of the heating roller 91 (a heat generating section is prepared substantially in the center in the longitudinal direction of the heating roller 91). The heater lamp (side lamp) 95b heat (substantially) both the end sides (in the longitudinal direction) of the heating roller 91, i.e., areas on the outer sides with respect to the center in the longitudinal direction of the heating roller 91 (a heat generating section includes heat generating sections divided into two to be on the outer side of the area heated by the heater lamp 95a in the longitudinal direction of the heating roller 91). The heater lamp (an auxiliary lamp) 95c heats substantially the entire area in the longitudinal direction of the heating roller 91. The heating ability of the heater lamp 95c is about a half of that of each of the heater lamps 95a and 95b and, in terms of power consumption (a heat value), about 300 W (watts). Therefore, the heating ability of each of the heater lamps 95a and 95b is about 600 W (watts).

A positional relation among heat sources of the heater lamps 95a, 95b, and 95c is schematically shown in FIG. 3.

Each of lamps 95a, 95b, and 95c are turned on at predetermined timings shown as TABLE 1 below by a heater driving (ON and OFF) circuit 15 (the heater driving (ON and OFF) circuit 15 feeds power to the heater lamps 95a, 95b, and 95c).

Thermistors (temperature sensors) 96 and 97 configured to detect the temperature of the surface of the heating roller 91 are respectively located substantially in the center and at an end in the longitudinal direction of the heating roller 91. A thermistor (a temperature sensor) 98 configured to detect the temperature of the surface of the pressing roller 92 is located substantially in the center in the longitudinal direction of the pressing roller 92.

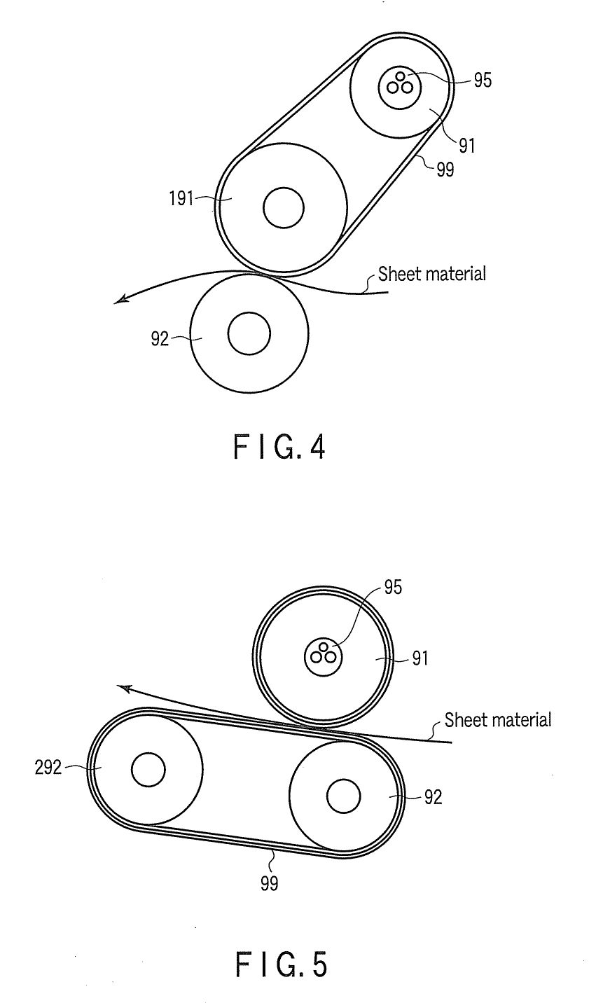

As shown in FIG. 4, it is also possible to adopt a configuration in which a belt member 99 in contact with the pressing roller 92 and a belt roller 191 forming the nip 90 between the pressing roller 92 and the belt member 99 are used and the heating roller 91 is not in direct contact with the pressing roller 92. In this case, the heating device 95 can be located on the outer circumference side of the belt member 99.

Further, it is also possible to adopt a configuration in which a belt member 99 in contact with the heating roller 91 and a belt roller 292 forming the nip between the heating roller 91 and the belt member 99 are used and the heating roller 91 is not in direct contact with the pressing roller 9, shown in FIG. 5.

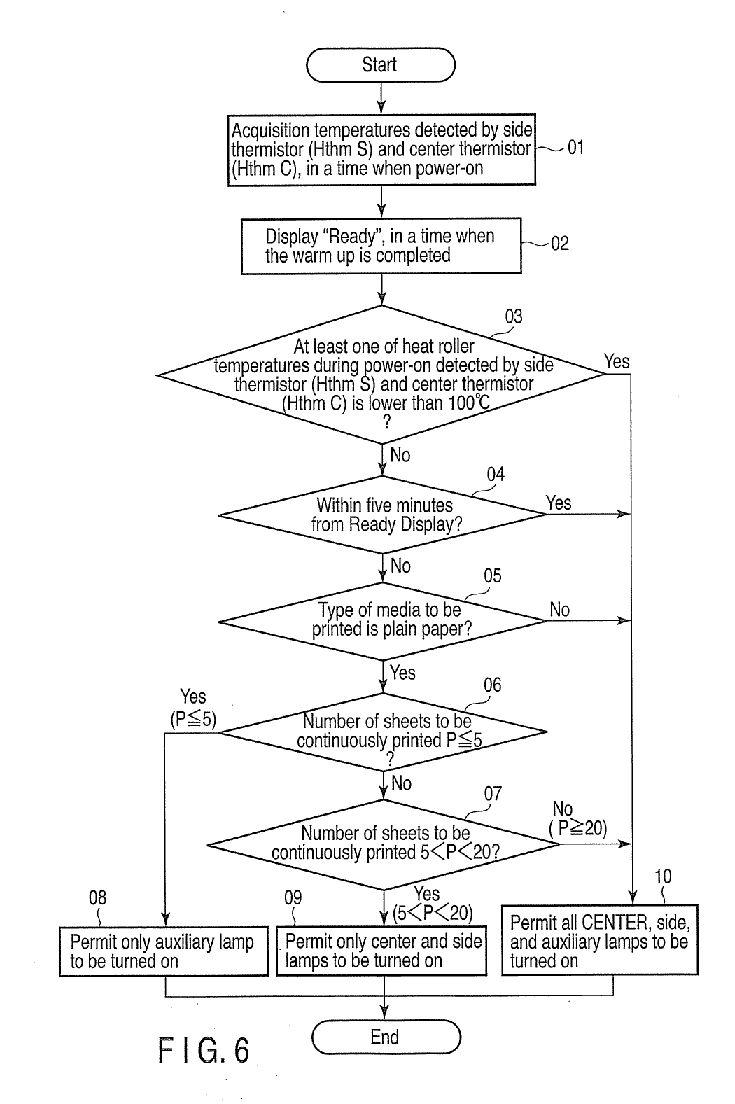

FIG. 6 shows an example of ON and OFF control for the heater lamps 95a, 95b, and 95c according to the predetermined timings shown in TABLE 1 below. Using temperatures of the outer circumference of the heating roller 91 detect with the temperature sensors (the thermistors) 96, 97, condition of outputting of image (thickness of the sheet material and the number of an input (the number of image forming of input), when to control the heater lamps 95a, 95b and 95c.

TABLE 1

| | | | | Special |
|---|---|---|---|---|
| | | | | paper |
| | | | | (thick |
| | | | | paper |
| | | | | 100 g/m² |
| | Plain paper (Number of sheets) | | | paper |
| | P ≦ 5 | 5 < P < 20 | 20 ≦ P | or thicker) |
| The fixing device is | Turn on the | ← | ← | ← |
| cooled (H/R | center, | | | |
| temperature during | side, and | | | |
| power-on is lower | auxiliary | | | |
| than 100° C. and | lamps | | | |
| five minutes | according to | | | |
| immediately after | necessity | | | |
| warming up) | | | | |
| The fixing device is | Turn on the | Turn on | Turn on | ← |
| cooled (H/R | auxiliary | the center, | the | |
| temperature during | lamp | and side | center, | |
| power-on is equal | | lamps | side, and | |
| to or higher than | | | auxiliary | |
| 100° C. or | | | lamps | |
| five minutes or more | | | according | |
| after warming up) | | | to | |
| | | | necessity | |

The thick paper is a thick sheet medium having weight (g) per 1 m² exceeding a predetermined threshold. The threshold is, for example, 100 g/m².

Lamps turn-on classifications shown in TABLE 1 are defined as explained [1], [2] or [3] below:

[1] only the auxiliary lamp (the heater lamp) 95c (power of which is about a half of that of the other heater lamps) is turned on (driven);

[2] the center lamp (the heater lamp) 95a and the side lamp (the heater lamp) 95b are turned on (driven); and

[3] all of the center lamp, side lamp, and auxiliary lamp are turned on (driven), according to necessity.

The lamps turn-on are controlled with condition of the number of image forming of input (the number of input) and thickness of the sheet material, in a case when the each of the heating roller temperature (side and center detect with the temperature sensors (the thermistors)) Hthm S and Hthm C are equal to or higher than 100° C. and five minutes after from end of the warming up is completed.

When, the number of input P are “P≦5” (the number of input sheets (instructed to be input for image output, hereinafter also referred to as “image output onto which is instructed”) is equal to or smaller than five (a sheet medium not thick paper), only the auxiliary lamp (the heater lamp) 95c (power of which is about a half of that of the other heater lamps) is turned on (driven).

If, the number of input P are “5<P<20” (the number of input sheets (image output onto which is instructed) is six to nineteen (printing on a sheet medium not thick paper), the center lamp (the heater lamp) 95a and the side lamps (the heater lamps) 95b are turned on (driven).

When, the number of input P are “20≦P” (the number of input sheets (image output onto which is instructed) is large (the number of input sheets is equal to or larger than twenty) or the sheet medium is thick paper, the center lamp, side lamp, and auxiliary lamps are turned-on, according to necessity.

More specifically, as shown in FIG. 6, acquisition temperatures detected by side thermistor (Hthm S) and center thermistor (Hthm C), in a time when after the power supply for the MFP 1 is turned on [01].

Display “Ready”, in a time when the warm up is completed [02].

Determination, at least one of heat roller temperatures detected by side thermistor (Hthm S) and center thermistor (Hthm C) is lower than 100° C. (all of temperatures detected with side thermistor (Hthm S) and center thermistor (Hthm C) are equal to 100° C. or over 100° C.)? [03].

Detection, five minutes after from “Ready” Display (five minutes passed after display “Ready”)? [04], if both of heat roller temperatures detected by side thermistor (Hthm S) and center is equal to or higher than 100° C.? [03—NO].

Detection, type of media (sheet material) to be printed is plain paper (thickness of sheet material is thinner of predetermined thickness)? [05], if five minutes after from Ready Display? [04—YES].

Detection, number of sheets to be continuously printed (number of input (indicated output of image)) P≦5? [06—YES], if type of media (sheet material) to be printed is plain paper? [05—YES], permit only auxiliary lamp to be turned on (applied to pattern [1]) [08].

Detection, number of sheets to be continuously printed (number of input (indicated output of image)) 5<P<20 (number of sheet P is 6 to 19)? [07—YES], permit only center and side lamps to be turned on (applied to pattern [2]) [09].

If, number of sheets to be continuously printed (number of input (indicated output of image)) 20≦P (number of sheet P is over 20) [07—NO], type of media (sheet material) to be printed is plain paper is not thinner of predetermined thickness (thickness of sheet material is thinner of predetermined thickness)? [05—NO], and both of heat roller temperatures detected by side thermistor (Hthm S) and center is equal to or higher than 100° C.? [03—YES] permit all of the center lamp, the side lamp, and the auxiliary lamp to be turned on, according to necessity (applied to pattern [3]) [10].

As explained above, with the control of changing power supply to the heat sources of the heating units according to elapse time from power supply to the heat sources, the number of sheet media to be continuously processed, and a type of the sheet media, power consumption for printout can be reduced to about 50% in an MFP that is often used to repeatedly input five or less sheets (image output onto which is instructed) in the ready state (five minutes after from end of the former printout is completed)

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A fuser comprising:
a heating unit configured to heat a toner to be fixed on a sheet medium and the sheet medium and including at least three heat sources that can be independently driven;
a temperature detecting unit configured to detect temperature of the heating unit in at least two positions spaced apart in a longitudinal direction of the heating unit; and
a control unit configured to change power supply to the heat sources of the heating unit according to elapse time from the power supply to the heat sources, a number of sheet media to be continuously processed, and a type of the sheet media.

2. The fuser of claim 1, wherein the three heat sources of the heating unit include first and second heat sources, heating areas of which in the longitudinal direction of the heating unit are different from each other, and a third heat source that heats substantially an entire area in the longitudinal direction of the heating unit.

3. The fuser of claim 2, wherein power of the third heat source of the heating unit is smaller than power of the first and second heat sources of the heating unit.

4. The fuser of claim 3, wherein the power of the third heat source of the heating unit is a half of the power of the first or second heat source of the heating unit.

5. The fuser of claim 4, wherein the fuser can fix the toner on a sheet medium using only the third heat source.

6. The fuser of claim 1, wherein the three heat sources of the heating unit include a first heat source that heats a center in the longitudinal direction of the heating unit, a second heat source that heats an end in the longitudinal direction of the heating unit, and a third heat source that heats substantially an entire area in the longitudinal direction of the heating unit.

7. The fuser of claim 6, wherein the power of the third heat source of the heating unit is smaller than power of the first and second heat sources of the heating unit.

8. The fuser of claim 7, wherein the power of the third heat source of the heating unit is a half of the power of the first or second heat source.

9. The fuser of claim 8, wherein the fuser can fix the toner on a sheet medium using only the third heat source.

10. A method to fuse a visualizing agent on a sheet material, comprising:
acquiring information concerning of elapsed time from power supply to heat sources, a number of sheet media to be continuously processed, and a type of the sheet media; and
selectively driving, according to the acquired information, at least one of at least three heat sources that can be independently driven and heating a toner to be fixed on a sheet medium and the sheet medium.

11. The method of claim 10, wherein the three heat sources includes first and second heat sources, heating areas of which in a longitudinal direction of a heating unit are different from each other, and a third heat source that heats substantially an entire area in the longitudinal direction of the heating unit.

12. The method of claim 11, wherein the power of the third heat source is smaller than power of the first and second heat sources.

13. The method of claim 12, wherein the power of the third heat source is a half of the power of the first or second heat source.

14. The method of claim 13, wherein the toner can be fixed on a sheet medium using only the third heat source.

15. The method of claim 10, wherein the three heat sources include a first heat source that heats a center in a longitudinal direction of a heating unit, a second heat source that heats an end in the longitudinal direction of the heating unit, and a third heat source that heats substantially an entire area in the longitudinal direction of the heating unit.

16. The method of claim 15, wherein the power of the third heat source is smaller than power of the first and second heat sources.

17. The method of claim 16, wherein the power of the third heat source is a half of the power of the first or second heat source.

18. The method of claim 17, wherein the toner can be fixed on a sheet medium using only the third heat source.

19. An image forming apparatus comprising:
a toner image forming unit configured to provide a toner to an output image and form a toner image;
a toner image moving unit configured to move the formed toner image onto a sheet medium; and
a fuser including:
a heating unit configured to heat the toner to be fixed on the sheet medium and the sheet medium and including at least three heat sources that can be independently driven;
a temperature detecting unit configured to detect temperature of the heating unit in at least two places spaced apart in a longitudinal direction of the heating unit; and
a control unit configured to control power supply to the heating unit according to the temperature of the heating unit detected by the temperature detecting unit and a remaining number of times the toner image is moved onto sheet media.
